(19) United States
(12) Patent Application Publication
(10) Pub. No.: US 2005/0206588 A1
(43) Pub. Date: Sep. 22, 2005

(54) Display apparatus

(75) Inventors: Jong-sul Min, Hwasung-si (KR); Hwa-seok Seong, Suwon-si (KR); Ho-seop Lee, Seoul (KR); Young-sun Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/078,662

(22) Filed: Mar. 14, 2005

(30) Foreign Application Priority Data
Mar. 12, 2004 (KR) 2004-16985

(51) Int. Cl. G09G 3/28

(52) U.S. Cl. 345/63

(57) ABSTRACT

A display apparatus with a display part displaying a picture thereon, the display apparatus including a brightness level determiner to determine a brightness level of the video signal and a sub-field coder to change the video signal into a sub-field code word formed as binary data that is sequentially arranged with respect to a plurality of sub-fields and representing a luminescence state of the pixel of the display part at each sub-field, and to output the sub-field code word to the display part. A luminescence pattern generator determines the number of sustaining pulses applied to the plurality of sub-fields forming the frame according to the brightness levels determined by the brightness level determiner, and transmits the sustaining pulses to the display part during a luminescence period of each sub-field until the number of representable gradation levels is equal to the number of sustaining pulses for the frame.

### CROSS-REFERENCE TO RELATED APPLICATIONS

This application claims the benefit of Korean Patent Application No. 2004-16985, filed Mar. 12, 2004, in the Korean Intellectual Property Office, the disclosure of which is incorporated herein by reference.

### BACKGROUND OF THE INVENTION

1. Field of the Invention

The present invention relates to a display apparatus, and more particularly, to a display apparatus, which displays a picture by processing a plurality of sub-fields time-sharing a frame of a video signal.

2. Description of the Related Art

FIG. 1 illustrates a frame and a time-sharing sub-field in a plasma display panel (PDP) as an example of a display apparatus.

As shown in FIG. 1, one frame is divided into a plurality of sub-fields, and the respective sub-fields correspond to a reset period, an address period, and a sustaining period. During the reset period, a pixel of the PDP is initialized as to a luminescence state. During the address period, the pixel is selected to emit light. During the sustaining period, the pixel selected in the address section is allowed to sustain its luminescence state. At this time, a period of luminescence time is increased in proportion to the number of sustaining pulses transmitted to the PDP during the sustaining period. Therefore, the number of sustaining pulses per frame determines the maximum brightness level of a picture, and thus the representable gradation level is determined according to how many sustaining pulses are weighted to each sub-field.

FIG. 2 is a block diagram of processing a sub-field in a conventional PDP.

As shown in FIG. 2, the PDP comprises a reverse gamma corrector 101, an error diffusing part 102, an automatic picture level (APL) calculator 103, a sub-field coder 104, a display part 105, and a controller 106.

The reverse gamma corrector 101 converts an input video signal on the basis of the following Equation (1). Here, the input video signal includes information about the respective brightness levels of red, green and blue (RGB) colors. Further, supposing that the information about the input/output brightness level is an integer, the information about the right side of a decimal point is an error.
Y=X^{2.2} Equation (1)
(where, “X” is the input video signal, “Y” is the output video signal)

The error diffusing part 102 allows such error to be reflected in the brightness level of an adjacent pixel. That is, the error diffusing part 102 adds the error to the brightness level of the adjacent pixel and reflects the error of the adjacent pixel in the brightness level inputted from the reverse gamma corrector 101, thereby transmitting an output signal to the APL calculator 103.

The APL calculator 103 calculates an average brightness level during one frame with respect to the output signal of the error diffusing part 102, and calculates the number of available sustaining pulses per one frame. The APL calculator 103 decreases the number of sustaining pulses when the average brightness level is higher than a predetermined reference brightness level, and increases the number of sustaining pulses when the average brightness level is lower than the reference brightness level. Then, the APL calculator 103 transmits the output signal from the error diffusing part 102 to the sub-field coder 104.

The sub-field coder 104 receives the output signal for the brightness level from the APL calculator 103 and converts the brightness level into a preset sub-field code word, thereby transmitting the sub-field code words to the display part 105.

Here, the sub-field code words are a sequential array of binary data with respect to the plurality of sub-fields, wherein the binary data represents the luminescence state of the pixel of the display part 105 according to the gradation levels with respect to each sub-field. For example, in the case of eight sub-fields, the sub-field code words for one pixel are represented as 8-bits. By the way, in the case where the number of pixels of the display part 105 is “N”, the sub-field code words are provided as N-bites. Such sub-field code words are inputted to the display part 105 during the address period of the sub-field, thereby determining which pixels of the display part 105 will emit light during the sustaining period of the same sub-field.

The controller 106 receives the information about the number of available sustaining pulses for the frame, which is calculated by the APL calculator 103. On the basis of the number of sustaining pulses for the frame, the controller 106 determines an output bit of the reverse gamma corrector 101, the number of sub-fields of the sub-field coder 104, and the number of sustaining pulses for each sub-field. The sustaining pulses shared to each sub-field allow the pixels selected based on the sub-field code words to emit light during the sustaining period of the corresponding sub-field.

Hereinbelow, operations of the PDP will be schematically described with reference to FIG. 2.

Suppose that the controller 106 determines the output bit of the reverse gamma corrector 101 as 10-bit on the basis of the information about the number of sustaining pulses per one frame received from the APL calculator 103. In this case, upper 8-bits indicate an integer portion of the converted brightness level, and lower 2-bits indicate an error portion of the converted brightness level as the right sides of the decimal point. The lower 2-bits is reflected by the error diffusing part 102 in the brightness level of the adjacent pixels. Further, the error diffusing part 102 reflects the errors of the adjacent pixels in the brightness level of the upper 8-bits, thereby transmitting the output signal to the sub-field coder 104 via the APL calculator 103. The sub-field coder 104 transmits the sub-field code words corresponding to the brightness level of the upper 8-bits to the display part 105 during the address period. Thus, the selected pixels sustain the luminescence state during the sustain period in response to the sustain pulses inputted from the controller 106.

However, when the average brightness level is lowered, the conventional PDP increases the number of sustain pulses for each sub-field by an integer multiple, so that the number of representable gradation levels is not improved as compared with the number of sustain pulses per one frame. Such problem arises even though the number of sustaining pulses is limited to 2ⁿ (2 to the n-th power). For example, even if the APL calculator 103 calculates eight hundred available sustaining pulses per frame, five hundred and twelve sustaining pulses are shared to each sub-field, thereby limiting the number of representable gradation levels to five hundred and twelve. Besides, in the conventional PDP, the number of representable gradation levels can be increased by increasing the number of sub-field code words, but, in this case, a false contour is increased in a moving picture displayed in the display part 105.

### SUMMARY OF THE INVENTION

Illustrative, non-limiting embodiments of the present invention overcome the above disadvantages, and other disadvantages not described above.

An apparatus consistent with the present invention provides a display apparatus, in which a gradation level is fully divided corresponding to the number of available sustaining pulses and a moving picture is displayed with a low false contour.

The foregoing and/or other aspects of the present invention are also achieved by providing a display apparatus with a display part displaying a picture thereon by allowing pixels to emit light in proportion to the number of sustaining pulses inputted during a luminescence period of a plurality of sub-fields time-sharing a frame of a video signal. The display apparatus comprises a brightness level determiner to determine a brightness level of the video signal. A sub-field coder changes the video signal into a sub-field code word formed as binary data that is sequentially arranged with respect to a plurality of sub-fields and representing a luminescence state of the pixel of the display part at each sub-field, and to output the sub-field code word to the display part. A luminescence pattern generator determines the number of sustaining pulses applied to the plurality of sub-fields forming the frame according to the brightness levels determined by the brightness level determiner, and transmits the sustaining pulses to the display part during a luminescence period of each sub-field until the number of representable gradation levels is equal to the number of sustaining pulses for the frame.

According to an aspect of the present invention, the luminescence pattern generator transmits one sustaining pulse to the display part in at least one sub-field.

According to an aspect of the present invention, the luminescence pattern generator comprises a pulse table to store information about the number of sustaining pulses to be transmitted to the display part at each sub-field.

According to another aspect of the present invention, the display apparatus further comprises a code word generator generating the sub-field code word to reduce the number of sub-fields which are changed in a luminescence state between adjacent gradation levels, to be lower than a predetermined reference varying number, wherein the sub-field coder changes the brightness level of the video signal into the gradation level based on the sub-field code word generated by the code word generator, and outputs the corresponding sub-field code word to the display part.

According to an aspect of the present invention, the sub-field coder comprises a gradation calculator to calculate the gradation level corresponding to the brightness level determined by the brightness level determiner; and a representable gradation compensator to change the brightness level of the video signal into one among the sub-field code words corresponding two gradation levels according to the gradation level calculated by the gradation calculator to be representable as the sub-field code word by the code word generator.

According to an aspect of the present invention, the representable gradation compensator changes the brightness level into one of the corresponding sub-field code words on the basis of a relative gradation difference between the gradation level of the brightness level and the adjacent gradation levels.

According to an aspect of the present invention, the representable gradation compensator changes the brightness level into one of the corresponding sub-field code words on the basis of a predetermined weighted value according to positions of the pixel.

According to an aspect of the present invention, the code word generator generates the sub-field code word according to the brightness levels determined by the brightness level determiner.

According to another aspect of the present invention, the display apparatus further comprises a histogram part to calculate a brightness distribution of a frame with respect to the gradation level, wherein the luminescence pattern generator outputs the sustaining pulses to the display part during the luminescence period so as to share a concentrated gradation range to all representable gradation levels in the case where the brightness distribution of the frame calculated by the histogram part leans to a predetermined gradation range beyond a predetermined percentage.

According to another aspect of the present invention, the display apparatus further comprises a gradation converter to lower the gradation level related to the brightness level beyond a predetermined critical upper limit, to convert the brightness level of the video signal to make the critical upper limit have the maximum gradation level, and to output the converted brightness level to the sub-field coder when the gradation range is formed below the critical upper limit.

According to another aspect of the present invention, the display apparatus further comprises a peak level detector to detect the maximum brightness level of the frame and to output the detected maximum brightness level to the gradation converter.

According to another aspect of the present invention, the code word generator generates the sub-field code word forming unrepresentable gradation levels according to the luminescence states of each sub-field when the gradation range is formed beyond a predetermined critical lower limit.

According to another aspect of the present invention, a display apparatus has a display part displaying a picture thereon by allowing pixels to emit light in proportion to the number of sustaining pulses inputted during a luminescence period of a plurality of sub-fields time-sharing a frame of a video signal. The display apparatus comprises a brightness level determiner to determine a brightness level of the video signal; a luminescence pattern generator to transmit the sustaining pulses to the display part during a luminescence period of each sub-field; a code word generator generating a sub-field code word to reduce the number of sub-fields which are changed in a luminescence state between adjacent gradation levels, to be lower than a predetermined reference varying number; and a sub-field code to change the brightness level of the video signal into the gradation level based on the sub-field code word generated generator, and to output the corresponding sub-field code word to the display part.

According to an aspect of the present invention, the sub-field coder comprises a gradation calculator to calculate the gradation level corresponding to the brightness level determined by the brightness level determiner; and a representable gradation compensator to change the brightness level of the video signal into one among the sub-field code words corresponding two gradation levels adjacent to the gradating level calculated by the gradation calculator to be representable as the sub-field cord word by the code word generator.

According to another aspect of the present invention, the representable gradation compensator changes the brightness level into one of the corresponding sub-field code words on the basis of a relative gradation difference between the gradation level of the brightness level and the adjacent gradation levels.

According to another aspect of the present invention, the representable gradation compensator changes the brightness level into one of the corresponding sub-field code words on the basis of a predetermined weighted value according to positions of the pixel.

### BRIEF DESCRIPTION OF THE DRAWINGS

The above and other objects and advantages of the present invention will become apparent and more readily appreciated from the following description of exemplary embodiments, taken in conjunction with the accompanying drawings of which:

FIG. 1 is a view of a frame and a time-sharing sub-field in a plasma display panel (PDP);

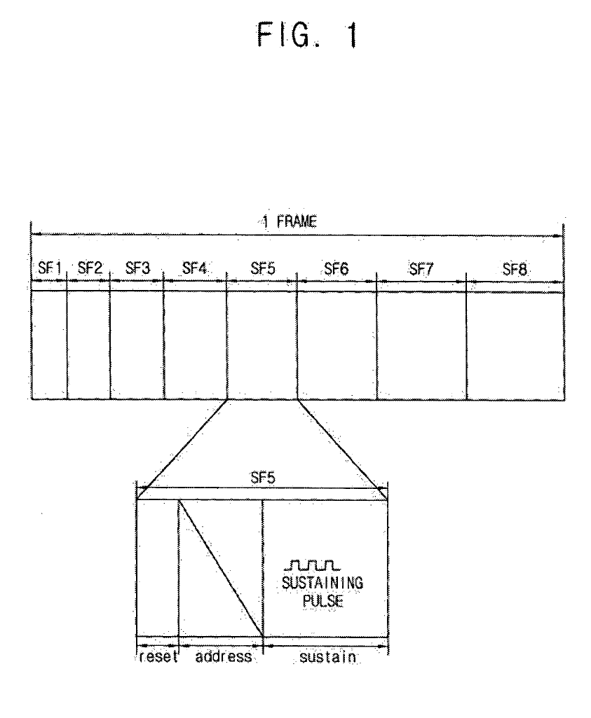

FIG. 2 a block diagram of processing a sub-field in a conventional PDP;

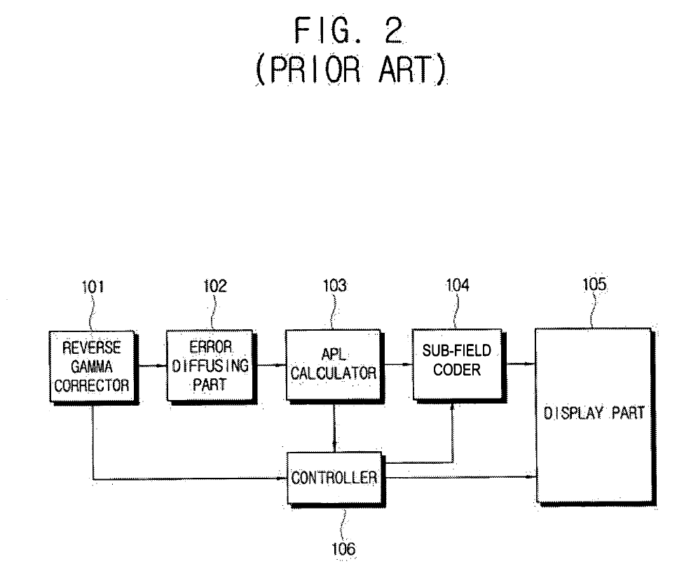

FIG. 3 is a schematic block diagram of processing a sub-field in a display apparatus according to a first embodiment of the present invention;

FIG. 4 is a schematic block diagram of decreasing a false contour of a moving picture in a display apparatus according to a second embodiment of the present invention;

FIG. 5 is a table showing sub-field code words with respect to twelve sub-fields and corresponding gradation levels by way of example;

FIG. 6 is a schematic block diagram of decreasing multi-gradations in a display apparatus according to a third embodiment of the present invention;

FIG. 7A is a histogram of a brightness distribution with respect to a gradation range below its critical upper limit;

FIG. 7B is a histogram of the brightness distribution with respect to a narrow gradation distribution in a gradation range below its critical upper limit; and

FIG. 8 is a graph showing input/output properties of a gradation converter that decreases a brightness level at a gradation having a low distribution ratio.

### DETAILED DESCRIPTION OF THE EXEMPLARY EMBODIMENTS OF THE PRESENT INVENTION

Reference will now be made in detail to exemplary embodiments of the present invention, examples of which are illustrated in the accompanying drawings, wherein like reference numerals refer to like elements throughout. The exemplary embodiments are described below in order to explain the present invention by referring to the figures.

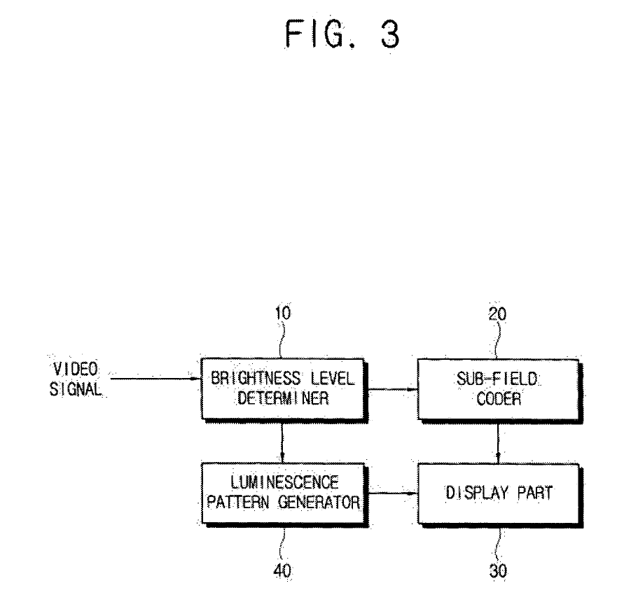

FIG. 3 is a schematic block diagram of processing a sub-field in a display apparatus according to a first embodiment of the present invention.

As shown in FIG. 3, a display apparatus according to the first embodiment of the present invention comprises a brightness level determiner 10, a sub-field coder 20, a display part 30, and a luminescence pattern generator 40.

The brightness level determiner 10 determines a brightness level of a video signal including information about brightness and transmits the video signal to the sub-field coder 20. Here, the video signal is an external signal including information about the brightness of one of R/G/B colors, and may comprise various type signals processed in reverse gamma correction, error diffusion, etc. Further, the brightness level includes an average brightness level of pixels with respect to a frame.

The sub-field coder 20 outputs a sub-field code word to represent a gradation level corresponding to the brightness. Each sub-field code word is transmitted to the display part 30 as binary data during an address period of the corresponding sub-field.

The luminescence pattern generator 40 determines the maximum number of available sustaining pulses for the frame according to the brightness levels determined by the brightness level determiner 10. Then, during a luminescence period of each sub-field, that is, during a sustaining period, the sustaining pulses are transmitted to the display part 30 until the number of gradation level is equal to the maximum number of available sustaining pulses for the frame. Therefore, one sustaining pulse should be necessarily shared to the sub-field having the minimum number of sustaining pulses. Further, to represent two gradation levels, there is needed the sub-field having two sustaining pulses or there are needed two or more sub-fields each having one sustaining pulse. Thus, the sustaining pulses are shared and outputted, so that a picture can be displayed with the fully divided gradation levels even though the brightness level based on the video signal is changed, thereby improving gradation resolution.

Further, the sustaining pulses are shared to each sub-field, thereby determining a luminescence pattern of the sub-field. Such luminescence pattern can be stored in a pulse table as a pattern related to the number of sustaining pulses transmitted to the display part 30 during the sub-field in correspondence to the brightness level of the input video signal. The pulse table outputs the luminescence pattern selected corresponding to the input brightness pattern to the display part 30.

By the way, as the gradation levels are more narrowly divided, the number of sub-field code words is increased, so that a moving picture may be displayed with a false contour.

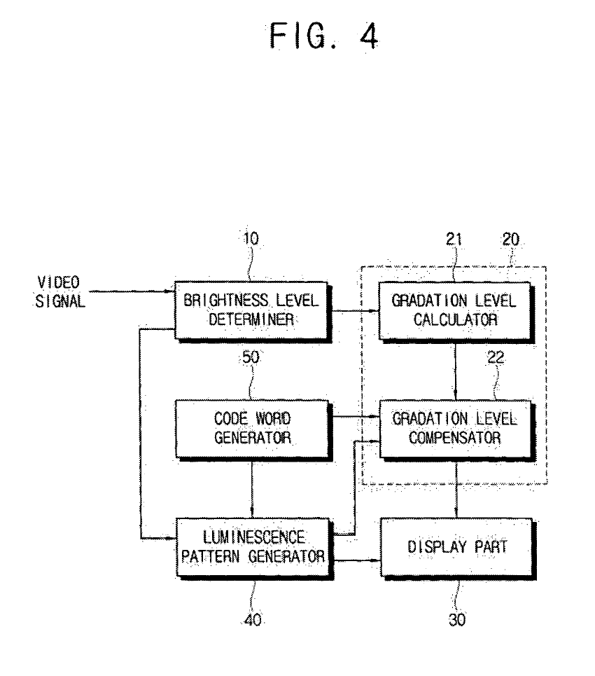

FIG. 4 is a schematic block diagram of decreasing a false contour of a moving picture in a display apparatus according to a second embodiment of the present invention.

As shown in FIG. 4, a display apparatus according to the second embodiment of the present invention comprises a brightness level determiner 10, a display part 30, a luminescence pattern generator 40, a code word generator 50, and a sub-field coder 20. Here, the brightness level determiner 10, the display part 30, and the luminescence pattern generator 40 according to the second embodiment are equal to those according to the first embodiment, so that repetitive descriptions thereof will be avoided.

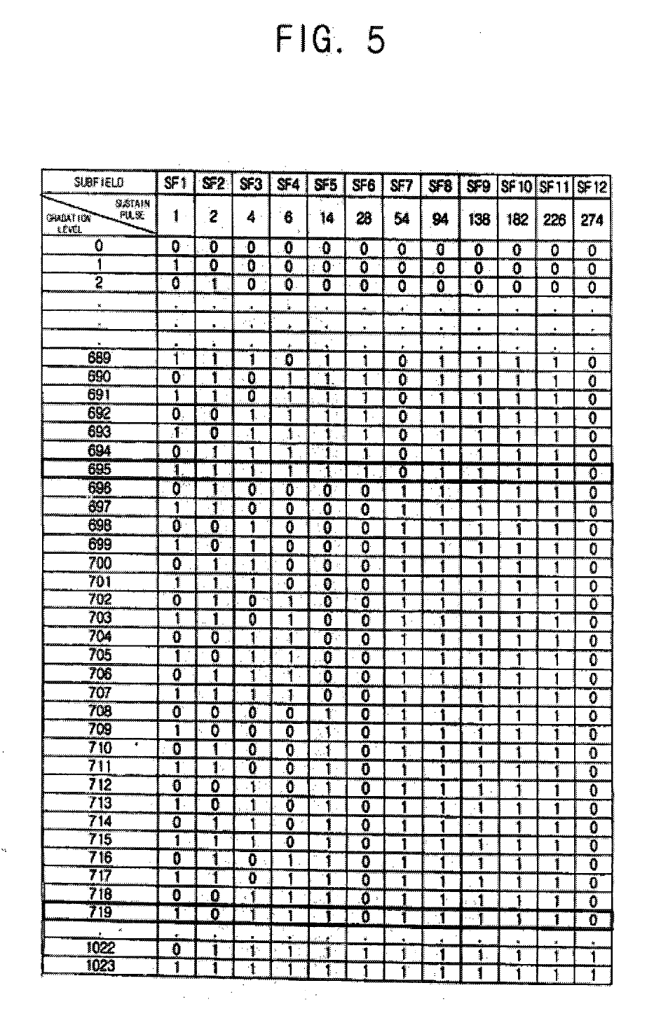

The code word generator 50 generates a sub-field code word to reduce the number of sub-fields which are changed in a luminescence state between adjacent gradation levels, to be lower than a predetermined reference varying number. The sub-field code words generated by the code word generator 50 are shown in the table of FIG. 5, by way of example.

The table in FIG. 5 shows the sub-field code words with respect to twelve sub-fields and the corresponding gradation levels by way of example. In the case of a reference varying number of 4, a gradation level of 719 is selected among the gradation levels adjacent to a gradation level of 695 because its number of sub-fields varying in the luminescent state satisfies the reference number of 4. Thus, the code word generator 50 generates serial sub-field code words satisfying the foregoing condition and outputs the serial sub-field code words to the sub-field coder 20.

The sub-field coder 20 codes the brightness level inputted from the brightness level determiner 10 into the sub-field code words generated by the code word generator 50.

Meanwhile, in FIG. 5, the gradation level of 695 and the gradation level of 719 are directly represented by the selected sub-field code words, so that they will be called an available gradation level. Oppositely, the gradation levels such as a gradation level of 700 between the gradation level of 695 and the gradation level of 719 are not directly represented, so that they will be called an unavailable gradation level. Thus, when the sub-field code word that reduces the number of sub-fields varying in the luminescence state to be lower than the reference number among adjacent gradation levels, is employed for the available gradation level, variance of the luminescence state between the sub-fields is relatively small, thereby effectively decreasing the false contour of the moving picture.

In this case, the number of sustaining pulses is not necessarily equal to the number of gradation levels. That is, in the Table, when the number of sustaining pulses of the sub-field-2 is changed from 2 to 1, a gradation level of 3 is not representable (hereinafter, referred to as “unrepresentable gradation level”), but there is an effect on decreasing the false contour of the moving picture.

Meanwhile, the video signal having the brightness of the unavailable gradation level can be processed to have the available gradation level by a multi-gradations process. Therefore, the sub-field coder 20 comprises a gradation calculator 21 and a representable gradation compensator 22, thereby performing a dithering process (see FIG. 4).

The gradation calculator 21 calculates the gradation level corresponding to the brightness level of the video signal determined by the brightness level determiner 10.

The representable gradation compensator 22 changes the brightness level of the video signal into one among the sub-field code words corresponding to the available gradation level adjacent to the gradation level calculated by the gradation calculator 21. For example, referring to the Table, when the gradation level calculated by the gradation calculator 21 is 700, the available gradation levels adjacent to the gradation level of 700 are 695 and 719, so that the representable gradation compensator 22 selects one of the sub-field code words corresponding to the gradation levels of 695 and 719, thereby transmitting the selected sub-field code word to the display part 30.

At this time, when the sub-field code word is selected corresponding to one of the adjacent gradation levels, the selection can be performed in consideration of several conditions. For example, a relative position between the gradation level of the video signal and the adjacent gradation level, and a position of the pixel can be weighted to the selection, thereby allowing a moving picture to be naturally displayed. Such conditions are reflected in the following Equation (2).
threshold value=S×(EDx−lower)/(upper−lower) Equation (2)
(where, “S” is a proportional constant; “Edx” is a gradation level of a video signal; “upper” is an upper adjacent gradation level; “lower” is a lower adjacent gradation level; and “threshold value” is a relative gradation difference.)

According to Equation (2), when “Edx” is equal to “lower”, “threshold value” is zero. When “Edx” is equal to “upper”, “threshold value” is “S”. Here, the threshold value represents the relative gradation difference between the gradation level of the video signal and the adjacent gradation level as a numerical value. Thus, the adjacent gradation level applied to the display part 30 can be selected according to the threshold values. Alternatively, weight based on the position of the pixel is added to the threshold value, and then the adjacent gradation level can be selected according to the weighted results.

Here, because the luminescence pattern, the available gradation level, etc., are changed according to the brightness levels of the video signal, the adjacent gradation level of Equation (2) is dynamically altered according to the brightness level. Hence, the multi-gradations process can be performed by a dynamic dithering method that adds the varying threshold value with a predetermined dither value corresponding to the position of the pixel. In addition to the dithering method, the multi-gradations process may be performed by an error diffusing method.

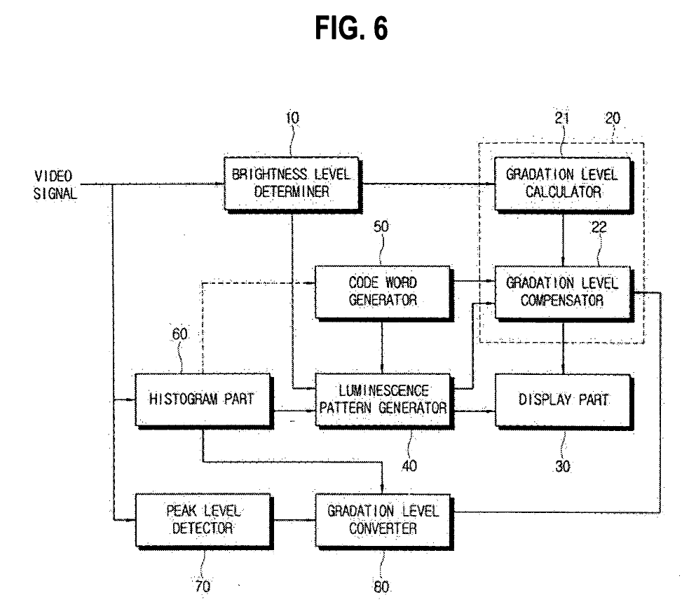

FIG. 6 is a schematic block diagram of decreasing multi-gradations in a display apparatus according to a third embodiment of the present invention.

As shown in FIG. 6, a display apparatus according to the third embodiment of the present invention comprises a brightness level determiner 10, a display part 30, a luminescence pattern generator 40, a code word generator 50, a sub-field coder 20, a histogram part 60, a peak level detector 70, and a gradation level converter 80. Here, differences between the third embodiment and the foregoing embodiments will be preponderantly described and repetitive descriptions thereof will be avoided.

The histogram part 60 calculates a brightness distribution of a frame with respect to the gradation level. That is, the histogram part 60 calculates a proportion of the number of pixels to the gradation level, which indicates what gradation level corresponds to each pixel in one picture displayed by one frame.

When the brightness distribution leans to a predetermined gradation range beyond a predetermined percentage, the luminescence pattern generator 40 adjusts the number of sustaining pulses to be outputted during the sustaining period of each sub-field so as to share the concentrated gradation range to all available gradation levels, thereby outputting the adjusted number of sustaining pulses to the display part 30. Hence, the gradation level, to which the brightness distribution of the input video signal leans, is subdivided, thereby enhancing the gradation resolution.

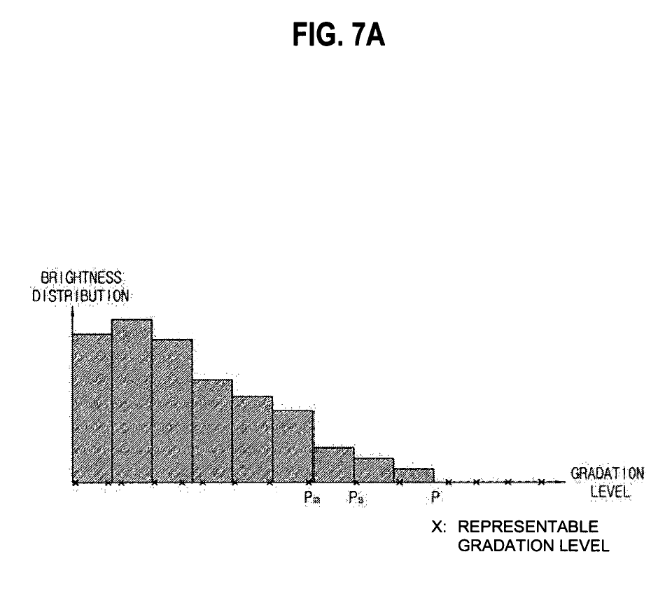

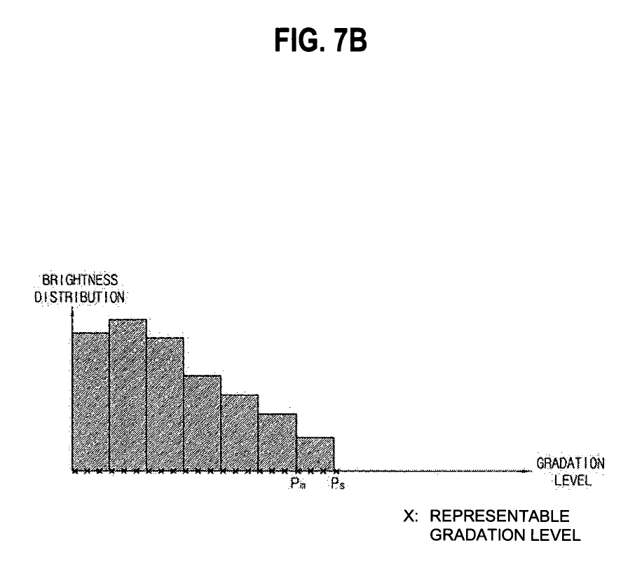

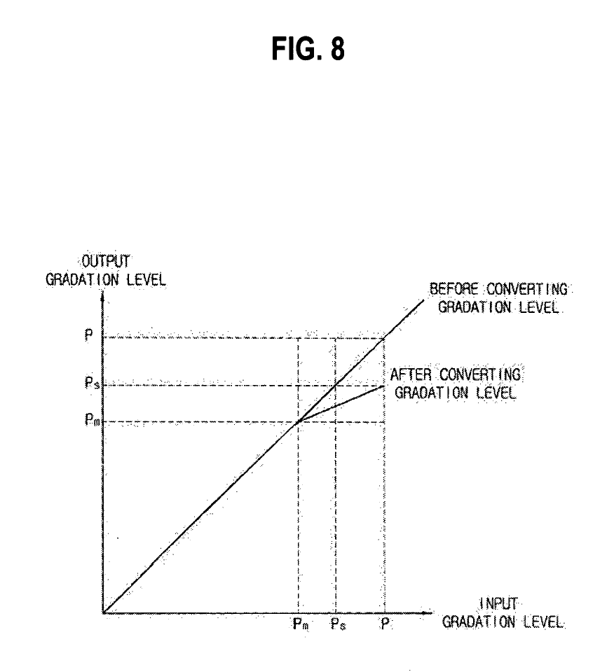

Hereinbelow, the third embodiment will be described with reference to FIGS. 7A through 8.

FIG. 7A is a histogram of a brightness distribution with respect to a gradation range below a predetermined critical upper limit, which is calculated by the histogram part 60.

Referring to FIG. 7A, the maximum gradation level of the video signal is “P”, and the critical upper limit is “Pₛ”. Throughout all the gradation levels, the brightness distribution is low as to the gradation range beyond “Pₛ”, so that the use of the representable gradation levels is not enough.

In this case, the luminescence pattern generator 40 effectively shares the sustaining pulses in order to subdivide the gradation level as to the gradation level range below “Pₛ”. For example, under the condition that the maximum gradation level is 1024, if the gradation level of “Pₛ” is 512, the number of available sustaining pulses per one frame can be reduced. Alternatively, the luminescence pattern and the sub-field code word may be reset to finely subdivide the representable gradation level below 512.

By the way, the information about the gradation level beyond the critical upper limit of “Pₛ” is thrown into the discard, so that an error is likely to be generated. However, because the gradation level distribution can be lowered due to noise, it is effective to eclectically lower the brightness level. For this reason, there are preferably provided the peak level detector 70 and the gradation level converter 80.

The peak level detector 70 calculates the maximum brightness level of the video signal.

The gradation level converter 80, when the foregoing gradation range is formed below a predetermined critical upper limit, lowers the gradation level related to the brightness level beyond the critical upper limit and converts the brightness level of the video signal to make the critical upper limit have the maximum gradation level, thereby outputting the converted brightness level to the sub-field coder 20. The gradation level beyond the critical upper limit is lowered as follows.

FIG. 8 is a graph showing input/output properties of a gradation converter that decreases a brightness level at a gradation having a low distribution ratio.

As shown in FIG. 8, an input gradation range of “Pₘ” “P” is converted into an output gradation range of “Pₘ” “Pₛ”. That is, an input/output property line has a gradient of 1 in the case of the input gradation level below “Pₛ”, whereas a gradient of 1 or less in the case of the input gradation level of “Pₘ”˜“P”. Thus, the gradation level having the low brightness distribution can be reflected in the gradation range for the finely subdivided gradation levels. Here, the input/output property is not necessarily a linear correlation and may be selected arbitrarily. Here, it is important to select the critical upper limit “Pₛ” and the reference gradation level “Pₘ”. Preferably, the gradation level, at which the accumulated brightness distribution from the maximum gradation level toward the decreasing gradation level has a predetermined percentage, is selected as the critical upper limit. Also, the reference gradation level can be selected by the same method as the critical upper limit, but different from the critical upper limit in the percentage of the brightness distribution.

To lower the gradation level of the input video signal with respect to the reference gradation level beyond “Pₘ”, the gradation level converter 80 outputs information about the critical upper limit and the reference gradation level to the representable gradation compensator 22. The representable gradation compensator 22 converts the output having the gradation level beyond the critical upper limit of “Pₛ” outputted from the gradation calculator 21 into the sub-field code words having the gradation level ranging between the reference gradation level “Pₘ” and the critical upper limit “Pₛ”, thereby transmitting the sub-field code words to the display part 30.

On the other hand, in the case where the foregoing gradation range is formed beyond a predetermined critical lower limit, the code word generator 50 generates the sub-field code word forming the foregoing unrepresentable gradation level according to the luminance state at each sub-field. Thus, the multi-gradations pattern due to the high brightness concentration is decreased.

As described above, the present invention provides a display apparatus, in which gradation resolution is improved and a false contour of a moving picture is decreased.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

1. A display apparatus with a display part displaying a picture thereon by allowing pixels to emit light in proportion to the number of sustaining pulses inputted during a luminescence period of a plurality of sub-fields time-sharing a frame of a video signal, the display apparatus comprising:
a brightness level determiner to determine a brightness level of the video signal;
a sub-field coder to change the video signal into a sub-field code word formed as binary data that is sequentially arranged with respect to a plurality of sub-fields and representing a luminescence state of the pixel of the display part at each sub-field, and to output the sub-field code word to the display part; and
a luminescence pattern generator to determine the number of sustaining pulses applied to the plurality of sub-fields forming the frame according to the brightness levels determined by the brightness level determiner, and to transmit the sustaining pulses to the display part during a luminescence period of each sub-field until the number of representable gradation levels is equal to the number of sustaining pulses for the frame.

2. The display apparatus according to claim 1, wherein the luminescence pattern generator transmits one sustaining pulse to the display part in at least one sub-field.

3. The display apparatus according to claim 1, wherein the luminescence pattern generator comprises a pulse table to store information about the number of sustaining pulses to be transmitted to the display part at each sub-field.

4. The display apparatus according to claim 1, further comprising a code word generator generating the sub-field code word to reduce the number of sub-fields which are changed in a luminescence state between adjacent gradation levels, to be lower than a predetermined reference varying number, wherein
the sub-field coder changes the brightness level of the video signal into the gradation level based on the sub-field code word generated by the code word generator, and outputs the corresponding sub-field code word to the display part.

5. The display apparatus according to claim 4, wherein the sub-field coder comprises:
a gradation calculator to calculate the gradation level corresponding to the brightness level determined by the brightness level determiner; and
a representable gradation compensator to change the brightness level of the video signal into one of the sub-field code words corresponding to two gradation levels which are adjacent to the gradation level calculated by the gradation calculator and representable as the sub-field code word by the code word generator.

6. The display apparatus according to claim 5, wherein the representable gradation compensator changes the brightness level into one of the corresponding sub-field code words on the basis of a relative gradation difference between the gradation level of the brightness level and the adjacent gradation levels.

7. The display apparatus according to claim 6, wherein the representable gradation compensator changes the brightness level into one of the corresponding sub-field code words on the basis of a predetermined weighted value according to positions of the pixel.

8. The display apparatus according to claim 4, wherein the code word generator generates the sub-field code word according to the brightness levels determined by the brightness level determiner.

9. The display apparatus according to claim 4, further comprising a histogram part to calculate a brightness distribution of a frame with respect to the gradation level, wherein
the luminescence pattern generator outputs the sustaining pulses to the display part during the luminescence period so as to share a concentrated gradation range to all representable gradation levels in the case where the brightness distribution of the frame calculated by the histogram part leans to a predetermined gradation range beyond a predetermined percentage.

10. The display apparatus according to claim 9, further comprising a gradation level converter to lower the gradation level related to the brightness level beyond a predetermined critical upper limit, to convert the brightness level of the video signal to make the critical upper limit have the maximum gradation level, and to output the converted brightness level to the sub-field coder when the gradation range is formed below the critical upper limit.

11. The display apparatus according to claim 10, further comprising a peak level detector to detect the maximum brightness level of the frame and to output the detected maximum brightness level to the gradation level converter.

12. The display apparatus according to claim 10, wherein the code word generator generates the sub-field code word forming unrepresentable gradation levels according to the luminescence states of each sub-field when the gradation range is formed beyond a predetermined critical lower limit.

13. A display apparatus with a display part displaying a picture thereon by allowing pixels to emit light in proportion to the number of sustaining pulses inputted during a luminescence period of a plurality of sub-fields time-sharing a frame of a video signal, the display apparatus comprising:
a brightness level determiner to determine a brightness level of the video signal;
a luminescence pattern generator to transmit the sustaining pulses to the display part during a luminescence period of each sub-field;
a code word generator generating a sub-field code word to reduce the number of sub-fields which are changed in a luminescence state between adjacent gradation levels, to be lower than a predetermined reference varying number; and
a sub-field coder to change the brightness level of the video signal into a gradation level based on the sub-field code word generated by the code word generator, and to output the corresponding sub-field code word to the display part.

14. The display apparatus according to claim 13, wherein the sub-field coder comprises:
a gradation calculator to calculate the gradation level corresponding to the brightness level determined by the brightness level determiner; and
a representable gradation compensator to change the brightness level of the video signal into one among the sub-field code words corresponding to two gradation levels adjacent to the gradation level calculated by the gradation calculator to be representable as the sub-field cord word by the code word generator.

15. The display apparatus according to claim 14, wherein the representable gradation compensator changes the brightness level into one of the corresponding sub-field code words on the basis of a relative gradation difference between the gradation level of the brightness level and the adjacent gradation levels.

16. The display apparatus according to claim 15, wherein the representable gradation compensator changes the brightness level into one of the corresponding sub-field code words on the basis of a predetermined weighted value according to positions of the pixel.

17. The display apparatus according to claim 13, wherein the code word generator generates the sub-field code word according to the brightness levels determined by the brightness level determiner.

18. The display apparatus according to claim 13, further comprising a histogram part to calculate a brightness distribution of the frame with respect to the gradation level, wherein
the luminescence pattern generator outputs the sustaining pulses to the display part during the luminescence period so as to share a concentrated gradation range to all representable gradation levels in the case where the brightness distribution of the frame calculated by the histogram part leans to a predetermined gradation range beyond a predetermined percentage.

19. The display apparatus according to claim 18, further comprising a gradation level converter to lower the gradation level related to the brightness level beyond a predetermined critical upper limit, to convert the brightness level of the video signal to make the predetermined critical upper limit have the maximum gradation level, and to output the converted brightness level to the sub-field coder when the gradation range is formed below the predetermined critical upper limit.

20. The display apparatus according to claim 19 further comprising a peak level detector to detect the maximum brightness level of the frame and to output the detected maximum brightness level to the gradation level converter.

21. The display apparatus according to claim 19, wherein the code word generator generates the sub-field code word forming unrepresentable gradation levels according to the luminescence states of each sub-field when the gradation range is formed beyond a predetermined critical lower limit.
